(19) United States
(12) Patent Application Publication
(10) Pub. No.: US 2013/0148100 A1
(43) Pub. Date: Jun. 13, 2013

(54) Method of Localizing Objects Temporarily Shadowing a PV System

(71) Applicant: SMA Solar Technology AG, Niestetal (DE)

(72) Inventors: Bjoern Magnussen, Kassel (DE); Rernhard Schropp, Kassel (DE)

(73) Assignee: SMA Solar Technology AG, Niestetal (DE)

(21) Appl. No.: 13/709,266

(22) Filed: Dec. 10, 2012

(30) Foreign Application Priority Data
Dec. 9, 2011 (DE) 102011056207.9

(51) Int. Cl. G01C 3/08

(52) U.S. Cl. CPC G01C 3/08
USPC 356/4.07

(57) ABSTRACT

A method of localizing stationary objects causing temporary shadowing of light sensitive components of a PV system is disclosed. The method includes analyzing an electrical signal of the light sensitive components with regard to an occurrence of a shadowing event caused by the stationary object, and determining from a solar altitude associated with the shadowing event a direction of the stationary object causing the shadowing event. The analysis of the electrical signal takes into account a shadow movement of the object as a function of the solar altitude. A distance of the object is determined from this analysis. The results of the method may be used to determine an energy loss associated with the stationary object and may support a decision on removal of the object to improve efficiency of the PV system.

### FIELD

The invention relates to a method of localizing stationary objects causing temporary shadowing of light sensitive components of a photovoltaic (PV) system.

### BACKGROUND

A display for energy generating systems is known from DE 20102619U1, wherein a daily target characteristic of the power provided by a PV system is calculated and continuously adapted to the maximum potential power by learning from error free real conditions. A prerequisite for this approach is the implementation of an additional light measuring unit for detecting the real light intensity. The calculation of an initial daily target characteristic is based on the location of the PV system (altitude and latitude), as well as the daily or monthly adapted solar altitude. This way, also limitations caused by the environment on the optimum alignment of the PV system's solar modules are regarded within the effective daily characteristic. The user is informed about deviations of the actual value from the taught target characteristic exceeding a predetermined threshold after the teaching phase. Solar module shadowing of the PV system are regarded within the taught target characteristics of the display, however, the shadowing is neither identified as such nor evaluated with regard to its significance.

A method of controlling a PV system is known from DE 102006008178A1. Comparative measurements between solar modules are performed to permanently control the system power. If deviations between the measured values are identified, this is understood as an indication of a need for a PV system check. Environmental disturbances such as shadowing effects by clouds, trees or buildings are to be distinguished from irreversible mechanical or electrical damages. Details of this distinction cannot be derived from DE 102006008178A1.

The method of determining the area of a structure usable for solar energy production is known from US 2009/0177458, wherein a three-dimensional model of the structure and the corresponding obstacles is created. Using the three-dimensional model, shadowing analysis is performed to determine the usable area of the structure.

A method of analyzing shadowing of at least one solar module is known from the post published EP 2395550. A shadowing probability value equal or larger than zero is set for all values of the solar altitude, for which the power produced by the solar module during the day falls short of an ideal power reference. The shadowing probability values are entered into a solid angle map for the corresponding solar altitude to provide an overview of the solar altitude values occurring in the course of the year. One axis of the map is assigned to the azimuth angle, while the other axis is assigned to the altitude angle of the solar altitude. The direction of the shadowing obstacle relative to the solar module can be derived from this map.

### SUMMARY

One aspect of the disclosure is to provide a method of localizing objects temporarily shadowing light sensitive components of a PV system in order to provide a basis for a tentative removal of the objects to eliminate energy loss associated with shadowing of the PV system.

One aspect of the present disclosure is to localize the root cause of a shadowing of light sensitive components of a PV system generating electrical energy. Shadowing is to be understood as the event of a substantially opaque, stationary object covering with its shadow light sensitive components of the PV system. Such objects are in the following also referred to as shadowing obstacles. These objects cause generally avoidable loss, e.g. by removal of the object, of the electrical energy produced by the PV system. According to this definition, clouds cause shadowing. A shadowing object may be subject to certain changes by wind and weather as well as to seasonal changes. For instance, this is the case for broadleaf trees or bushes, in particular when being cut back during the year.

Within this specification, claims or definition of the invention, the term “solar altitude” shall be construed to comprise the meaning of “time of day”. In other words, the solar altitude can be determined by referring to the time of a predetermined day, thereby neglecting changes of the solar altitude between successive days, although this is not precise.

In one aspect of the present invention, a method of localizing stationary objects causing temporary shadowing of light sensitive components of a PV system, at least one electrical signal of the light sensitive components is analyzed with regards to an occurrence of a shadowing event caused by the shadowing object. From solar altitude values associated with the shadowing event, a direction of the stationary object causing the shadowing event is determined. In addition, the at least one electrical signal is analyzed with regard to a shadow movement of the object across the light sensitive components as a function of the solar altitude, and a distance of the object is determined from this analysis.

The distance of the shadowing object is important information for the identification of the object, beside the direction of the object relative to the solar modules. Furthermore, the distance of the object by itself allows one to conclude on whether the object is located on the same estate as the PV system or a neighboring estate, to which access for removal of the object is restricted. The inventive method therefore provides important additional information for the PV system owner.

The electrical signal of the light sensitive components may further be analyzed whether the changes with varying solar altitude indicate at all to a shadowing event caused by stationary objects. A shadowing event within the meaning of the present disclosure for instance does not exist, if the movement direction of a shadow across the light sensitive components of the PV system is not opposite to the sun's movement. The movement speed of the shadow across the light sensitive components of the PV system may only, within certain limits, indicate a shadowing event caused by a stationary object. In contrast to this, a rapid movement of a shadow across the light sensitive components of the PV system may indicate an object moving or flying along.

The recognition of shadowing events caused by stationary objects, including other shadow-producing events onto light sensitive components of the PV system, may be used to distinguish a corresponding power reduction from internal operational faults of the PV system. This way, false error notifications of the internal operation of the PV system may be avoided, or algorithms for detection of such errors may be adjusted to be more sensitive without the risk of false error notification.

In order to observe the shadow movement across the light sensitive components with varying solar altitude within the electrical signal, the electrical signal may be analyzed with regard to the solar altitude, at which a shadow edge transits the light sensitive components. This may apply to the leading edge of the shadow, starting the shadowing event, or the trailing edge, ending the shadowing event. With transit of a shadow edge across the light sensitive components, the at least one electrical signal of the light sensitive components of the PV system changes in a particularly clear manner. The speed of the shadow edge movement may be derived, for example, from this change, in particular from the change rate of the electrical signal.

The distance of the object edge of the shadowing object from the light sensitive components can be directly derived from the movement of the corresponding shadow edge. In case that the distance values determined as described for different edges of the same single shadow differ significantly from each other, this may be interpreted as overlapping objects with regard to their shadowing. Furthermore, the electrical signal may be analyzed with regard to its frequency components during transit of a shadow edge across the light sensitive components. Such frequency components often allow one to conclude the nature of the object causing the shadowing. For example, an edge of a house may generate a different frequency spectrum of the at least one electrical signal as compared to a tree or a flag.

It often is worthwhile to analyze the at least one electrical signal for seasonal changes, if a shadowing event of a stationary object repetitively appears. This also allows to conclude to the nature of the shadowing. For example, the position of edges of a house usually does not change, while a broadleaf tree may show significant seasonal changes due the loss of leaves or a cut back.

The at least one electrical signal analyzed according to the inventive method may be caused by a single light sensitive component of the PV system, the component comprising a lateral extent in direction of the shadow movement, or by several light sensitive components distributed along this direction. In the first case, the signal starts to change as soon as the leading shadow edge reaches the light sensitive component. The signal change continues until the light sensitive components are fully shadowed by the shadowing object. A reverse change of the electrical signal starts, when the shadow starts to uncover the light sensitive component, i.e. when the trailing shadow edge reaches the light sensitive component. In the case of several light sensitive components arranged in direction of the shadow movement jointly generating the at least one electrical signal, the changes of the signal occur during transit of a shadow edge over the light sensitive components. Using such components arranged in direction of the shadow movement, it may be advantageous that the components provide individual electrical signals that can be attributed to single ones of the light sensitive components. This simplifies the signal analysis.

The direction of single features such as edges of the shadowing object relative to single light sensitive components, or parts thereof, may be derived from the shadow movement across the light sensitive components as a function of the solar altitude. The distance of the shadowing object may be derived by known triangulation methods from two or more of such directions.

The light sensitive components, from which electrical signals may be analyzed according to the disclosure, may be solar modules comprising a plurality of solar cells, single solar cells or even a string of a plurality of solar modules. It is further possible to use light detectors within the method according to the disclosure providing the electrical signal as light sensitive components, but not contributing to the power production of the PV system. These light detectors may form part of a sensor unit, and may be arranged within a predefined grid and with a predefined orientation.

Shadowing of the solar modules of the PV system may, for example, be detected by determining the electrical power produced by at least one solar module, and determining an ideal power characteristic based on electrical power values obtained during a plurality of days for corresponding solar altitudes, wherein the ideal power characteristics refers to cloudless insolation without shadowing objects over the course of the day adjusted to the peak power values at corresponding solar altitudes during the plurality of days. The shadowing is further detected by defining an expectation value of the electrical power produced by the solar module for each solar altitude during a current day, and determining deviations of the electrical power of the solar module from the ideal power characteristics during the current day, wherein for all solar altitudes, at which the electrical power produced by the solar module falls short of the ideal power characteristics, a shadowing probability greater or equal to zero is calculated based on the degree of coincidence of the electrical power produced by the solar module at the give solar altitude with the expectation value.

Within the approach, shadowing events are detected as a function of operational data of the solar module, i.e. without the use of an additional insolation sensor or shadowing sensor. This becomes possible by effectively eliminating statistical fluctuations from the expected power characteristics, so that only systematic fluctuations are included in the characteristics. The comparison of the expected power characteristics with the ideal power characteristics determined for the specific solar module allows one to draw reliable conclusions to the shadowing of the solar module as a function of solar altitude.

The power expectation value for each solar altitude may be defined as the peak value of the power at this solar altitude during a plurality of past days, and the shadowing probability value may scale with the degree of coincidence between the power expectation value and the power produced by the solar module.

In the cases mentioned above, but not necessarily, an ideal power characteristic is determined for detecting shadowing events in accordance with the procedures described. By only taking peak power values at a give solar altitude into account, just power conditions with no or minimum clouding conditions are regarded. The effects of shadowing, if present, however, are as well impacting the peak power values of the solar modules. To suppress the impact of shadowing, an ideal power characteristic is fitted to these peak power values during the plurality of past days, wherein the ideal power characteristic represents cloudless insolation with no shadowing objects over the whole day. A simple parabola may be used as the ideal power characteristic. Optionally, however, the ideal characteristic may be generated from physical modeling of the solar module taking into account the location and/or orientation of the solar module. The peak power values may be filtered or averaged prior to fitting with the ideal characteristic, for example, by averaging over the maximum power values determined at a given solar altitude or by even discarding the absolute peak values as high flyers and just regarding the next-highest power values. The fitting procedure itself may be a conventional, known fitting algorithm. The ideal daily characteristic determined this way may be used to identify the solar altitudes with produced daily power falling short of the ideal daily characteristics. A shadowing probability exists only in this case.

To identify the cause of falling short of the ideal characteristic, an expectation value of the power produced by the solar module is defined within the method of detecting shadowing described here. If only one solar module is regarded, this value corresponds to the above mentioned peak power value at the respective solar altitude during the past plurality of days. If this peak value, that may be averaged or filtered as described above in the context of determining the ideal power characteristics, is reached, and still the ideal power characteristics is fallen short of, this may be interpreted that the power produced by the solar module always falls short of the ideal power characteristic even at any cloudless day in a comparable manner. Based on this consideration, a shadowing probability equal or larger than zero is set within the new method for every solar altitude, at which the power produced by the solar module falls short of the ideal power characteristic. The probability value scales with the degree of coincidence between the power produced at the given solar altitude and the power expectation value. Within this approach, periodically repeating clouding events may influence the expectation value at certain solar altitudes. However, the probability, that this clouding impairs the power produced in comparison to the ideal power characteristic by the same percentage, is minimal. Within this new method this practically never leads to a wrong assumption of a shadowing event.

This is especially true, if in the case of a single solar module the shadowing probability for any solar altitude, at which the produced power of the solar module at the current day and the given solar altitude reaches or even exceeds the ideal power characteristic, is set to zero or below zero, because reaching the ideal power at this solar altitude is only possible without a shadowing event. Their use of the shadowing probability below zero may not immediately make logical sense. However, when averaging over probability values, negative single values of high statistical weight may be reasonable to compensate for presumably wrong positive probability values.

The expectation value for any solar altitude at a current day may be defined as a peak value of the normalized electrical power produced by a plurality of equivalent solar modules at the corresponding solar altitude and the current day. In this case, the value of the shadowing probability for each solar module scales with the extent of undershooting the expectation value by the normalized electrical power produced by the corresponding solar module and the given solar altitude.

If a plurality of solar modules and the corresponding power data are available, there is no need to use an expected power characteristic based on past measurement values for determining the power expectation value. Moreover, the normalized current peak power value of the individual solar modules may be defined as power expectation value, wherein the peak value may not necessarily be the present maximum normalized power value of a single solar module, but may for example as well be the 2nd or 3rd maximum value or an average value of a set of maximum values. Equivalence between the solar modules is only required to make sure that the power values may be normalized relative to each other. The normalizing procedure for mutually referencing the power values between solar modules may well be complex and is not limited to defining a proportionality factor between the modules.

By referencing to a power expectation value for each solar module based on the current electrical power of a plurality of solar modules, shadowing probability values of single solar modules at specific solar altitudes may not only be provided at cloudless sky, but as well at clouded conditions according to an embodiment of the method, if the shadowing event occurs despite the clouded condition. However, this option may not be utilized, and an embodiment of the method may limit the determination of shadowing probability values to a cloudless sky and corresponding conditions of maximum shadowing, since significant energy loss mainly occurs under such shadowing, and accordingly the evaluation of such loss needs to focus on such shadowing conditions.

Within a further embodiment of the method of detecting shadowing conditions, wherein the power expectation value is determined for each solar module, the shadowing probability for the corresponding solar module and solar altitude may be set to zero or below zero, if the power produced during a day reaches or even exceeds the normalized peak power of other equivalent solar modules, for example because the module itself provides for the peak power. Assuming the case of no synchronous shadowing of all solar modules, a single solar module may only provide for a peak power value at a given solar altitude, if it is not shadowed at this solar altitude.

The voltage generated by a single solar module has proven to be a non-reliable criterion per se for detecting shadowing of a solar module. Additionally, the voltage is not well suited for estimating the energy loss associated with a detected shadowing. However, when determining the power produced by a solar module, and a expectation value for the voltage associated with the produced power for each solar altitude at the current day is defined, a factor ranging between zero and one for the shadowing probability may be calculated, the factor increasing with the deviation of the generated voltage from the voltage expectation value. The voltage expectation value may be defined by forming average or median values of the individual voltages of a plurality of solar modules, or on the basis of the voltages of a single solar module at the moments of reaching peak power values at specific solar altitudes during a plurality of past days.

In one embodiment of the method of detecting shadowing, the results, i.e. the shadowing probability values, are entered into a solid angle map. In such a solid angle map, the azimuth angle of a solar altitude may be plotted along one axis, and the altitude angle may be plotted along another axis. The direction of shadowing objects relative to the respective solar module may be taken from this map.

After determining the direction of a feature of a shadowing object relative to two solar modules with known lateral offset, the distance of the object relative to the solar modules may be determined by triangulation methods. For this purpose, a center of an area with predominant shadowing probability may as well be used as specific features of those areas visible in both solid angle maps.

The distance information of the shadowing objects of the solar modules may then be added to one or both or a combined solid angle map.

Alternatively, a map such as a volume pixel map may be generated comprising ranges causing permanent shadowing and ranges not doing so. The location of shadowing objects may also be taken from such a map.

In one embodiment, ranges free of any cause of shadowing may be used to better localize shadowing causes. For those shadowing causes it is known, that they are located anywhere along the line between the light sensitive component and the sun. Therefore, when first entering into a map all volume pixels not comprising a permanent cause of shadowing, one may identify those volume pixels potentially comprising a shadowing course and attribute a probability of generating a shadowing to them.

In addition, the energy loss may be entered into the volume pixel map using the same principle. The volume pixel map may be reduced to a two-dimensional map by projection or intersection to simplify the presentation.

To reduce statistical scattering with regard to its impact, the distribution of shadowing probabilities within the solid angle map may be smoothed by averaging over neighboring values. Subsequently, the distribution of shadowing probabilities over the solid angle map may be filtered with regard to predominant shadowing probability. For this purpose, a suitable threshold of shadowing probability is set to identify a predominant shadowing probability. After filtering, the solid angle map contains those values of solar altitude, for which shadowing of the corresponding solar module is likely given.

For the ranges of the solid angle map with predominant shadowing probability, information related to the energy loss associated with the corresponding shadowing, such as a corresponding accumulated annual energy loss as likely associated with the shadowing during the last year, may be complimented. This way, a basis for deciding on the potential removal of shadowing objects or deciding on changing the arrangement of the solar modules is provided. Specifically, a lower altitude angle of the solar altitude may arbitrarily be defined and an associated accumulated annual energy loss may be calculated. This lower altitude angle may, for instance, be related to the height, to which a tree may be cut back. Accordingly, the associated accumulated annual energy loss provides information about how much additional energy could have been generated over the past year. The information related to the energy loss associated with a corresponding shadowing event may easily be determined from the electrical signals of the light sensitive components of the PV system not being shadowed.

Preferred further embodiments of the invention may be derived from the patent claims, the description of the drawings. The advantages mentioned in the introductory part of the specification related to features and combination of features are exemplary and may be effective in an alternative or cumulative manner without the requirement that all advantages need to be realized by an inventive embodiment. Without modifying the subject matter of the claimed invention the following applies to the disclosure of the invention: further features may be derived from the drawings, in particular the shown geometries and relative scaling of components as well as their relative arrangement and interaction. The combination of features of the different embodiments of the invention are of features of different patent claims is possible and explicitly motivated even when deviating from the specific references between claims and sub claims. This also relates to features shown in separate drawings or their corresponding description. These features may be combined with features of the patent claims. It is also to be understood that features mentioned in single patent claims may be omitted for further embodiments of the invention.

### BRIEF DESCRIPTION OF THE DRAWINGS

The invention is illustrated and described by variants with reference to the following figures:

FIG. 1 illustrates, how a shadow of a stationary object transits with varying solar altitude over two light sensitive components of a PV system,

FIG. 2 shows a time diagram of electrical signals of the two light sensitive components according to FIG. 1 based on a varying solar altitude,

FIG. 3 illustrates an example of an object being smaller and located closer to the light sensitive components as compared to the example of FIG. 1, and a transit of the object's shadow over the light sensitive components of the PV system of FIG. 1,

FIG. 4 shows a time diagram of electrical signals of the light sensitive components according to FIG. 3 in a plot substantially corresponding to FIG. 2,

FIG. 5 illustrates how to determine the distance between an object and the light sensitive components from two solar altitudes causing a shadowing of two light sensitive components by this same object,

FIG. 6 illustrates how to use the movement of a shadow edge of an object across a light sensitive component to determine the distance of a corresponding object edge from the corresponding solar altitudes, and

FIG. 7 shows a solid angle map comprising ranges with predominant shadowing probability by a shadowing obstacle for two different light sensitive components of a PV system.

### DETAILED DESCRIPTION

FIG. 1 shows two light sensitive components 1 and 2 of a PV system 3. The light sensitive components 1 and 2 may comprise single solar cells, solar modules, a plurality of solar modules, strings of a number of solar modules, or additional photo detectors not contributing to the electrical energy production by the PV system. A stationary object 4 is arranged in front of the light sensitive components 1 and 2, the light sensitive components 1 and 2 showing a lateral offset c in an east-west (O-W) direction. The shadow 6 of object 4 moves from west W to east O with sun 5 moving from east O to west W in a cloudless sky. A corresponding shadowing of the light sensitive components 1 and 2 starts with a leading edge 7 and ends with a trailing edge 8 of the shadow 6.

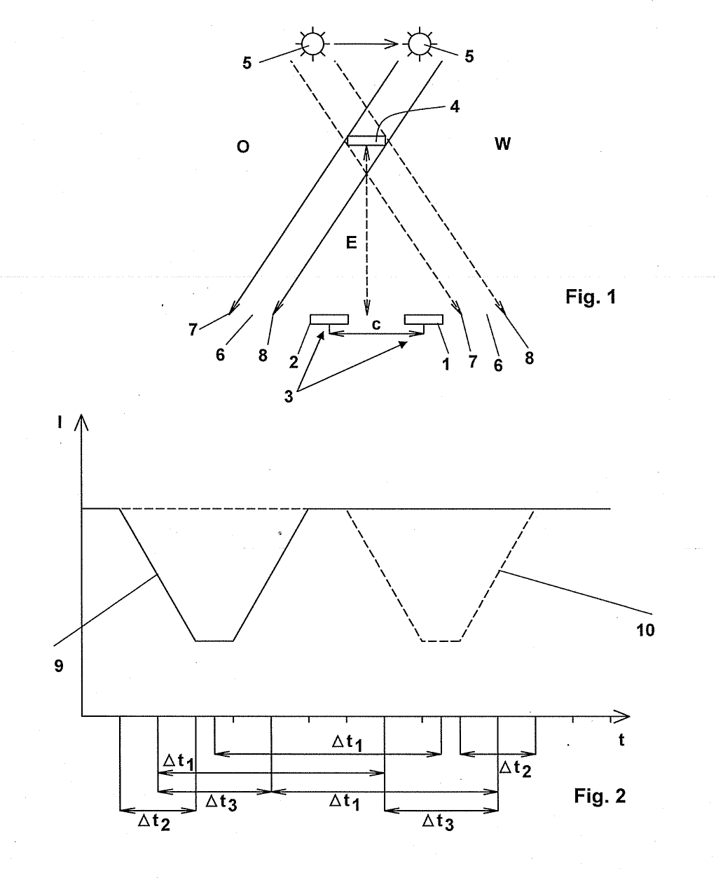

In FIG. 2, an electrical signal 9 of the light sensitive component 1 and an electrical signal 10 of the light sensitive component 2 are plotted over time, thus representing the light intensity I at the light sensitive component 1 and 2 during transition of shadow 6 according to FIG. 1, Signal 9 declines as soon as leading edge 7 reaches light sensitive component 1. The declination ends when shadow 6 fully covers light sensitive component 1. Signal 9 inclines again, as soon as trailing edge 8 reaches light sensitive component 1, and shadow 6 successively uncovers light sensitive component 1. Signal 10 shows the same effect with a time offset. The points in time plotted in the x direction in FIG. 2 are assigned to corresponding solar altitudes. The reciprocal value of the interval Δt₁ between corresponding changes of electrical signals 9 and 10 is a measure of the transition speed of shadow 6 across PV system 3. This speed also directly depends on the distance E between shadowing object 4 and PV system 3 according to FIG. 1. The larger the distance, the larger the transition speed. The interval Δt₁ may be determined based on the center point, the start point, the end point, or the mid points of either the declining portion or the inclining portion of the course of signals 9 and 10 as a consequence of the temporary shadowing of light sensitive component 1 and 2. A further measure of the transition speed is a time interval Δt₂, during which leading shadow edge 7 or trailing shadow edge 8 transits one of the light sensitive components. Alternatively, the change rate of signal 9 or 10 may be used to evaluate the transition speed of shadow 6 moving across the PV system 3. The time intervals Δt₃ shown in FIG. 2, between the moment of leading shadow edge 7 being located at the center of a corresponding light sensitive component 1 or 2 and the moment of trailing shadow edge 8 being located at the center of this corresponding light sensitive component 1 or 2, provide an indication on the dimension of shadowing object 4. The diagram shown in FIG. 2 is simplified, and some assumptions made may not always be adequate, e.g. the light intensity I may vary in a manner other than in accordance with the course of the solar altitude or the expected shadowing, or shadow 6 may not transit across light sensitive components 1 and 2 in the same way. However, the options to evaluate electrical signals 9 and 10 from light sensitive components 1 and 2 are in principle available.

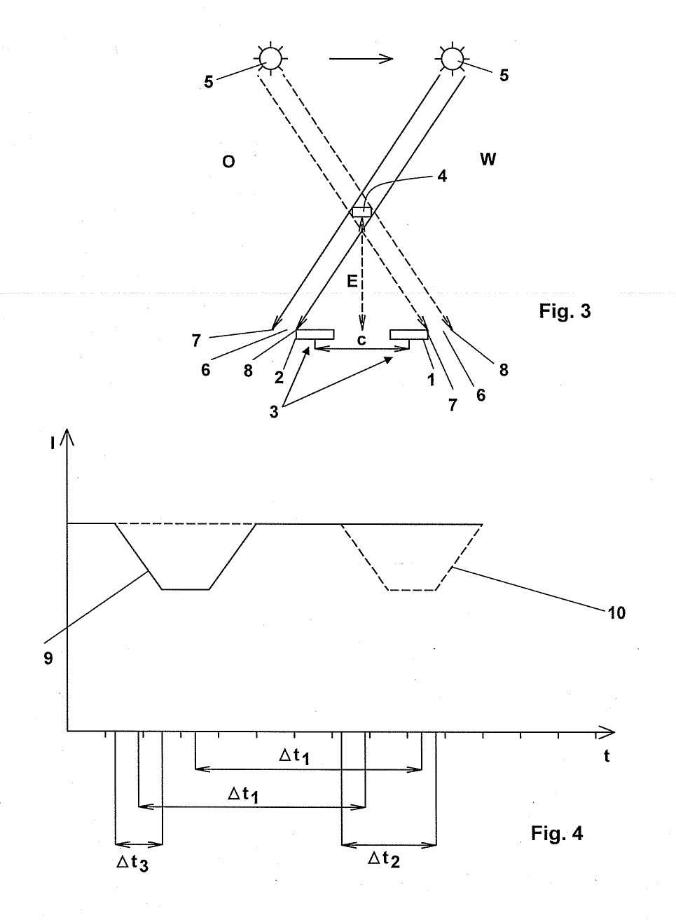

FIG. 3 illustrates the effect of a small object 4 being located in a close distance E from PV system 3 during the transition of shadow 6 across light sensitive components 1 and 2. The solid and dashed lines representing the shadowing process correspond to the same solar altitudes shown in FIG. 1 as an example. The direct comparison of both figures shows that shadow 6 moves by a smaller extent over PV system 3 for the closer object 4 of FIG. 3. Accordingly, signals 9 and 10 of the light sensitive components 1 and 2 plotted in FIG. 4, in particular the changes caused by the transiting shadow 6, are offset from each other by a larger time interval Δt₁. Since object 4 does not fully cover either of light sensitive components 1 and 2, the absolute change of signals 9 and 10 are smaller. In this example, the larger time interval Δt₁ of shadow 6 transiting the laterally spaced light sensitive components 1 and 2 may again be determined by one of the various corresponding points in time between signals 9 and 10. The time interval Δt₂ of leading edge 7 or trailing edge 8 of shadow 6 transiting light sensitive components 1 and 2 includes the time interval, where the corresponding signal 9 and 10 does not drop further. In contrast to this, the time interval Δt₃ indicating the size of object 4 is in this example just as large as the declination or the inclination portion of signals 9 and 10. Both situations of FIG. 1 and FIG. 3 may occur with objects 4 of different size at the same light sensitive components 1 and 2, however, by choosing light sensitive components 1 and 2 of small light sensitive area, the case of FIG. 1 becomes the normal case.

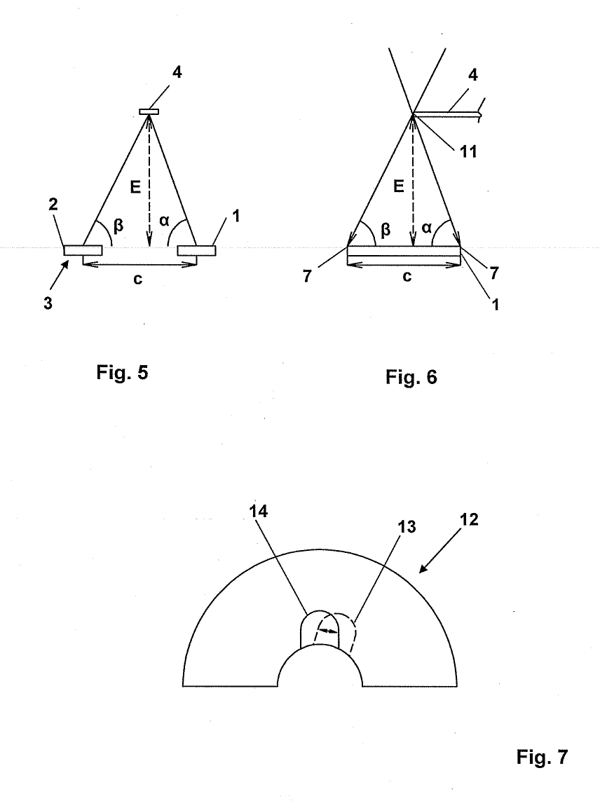

FIG. 5 illustrates how to determine the distance E of object 4 of PV system 3. The solar altitude at the moment, when the shadow of object 4 is located at the center of light sensitive component 1, defines angle α, and the solar altitude at the moment, when the shadow of object 4 is located at the center of light sensitive component 2, defines angle β. By lateral offset c of light sensitive component 1 relative to light sensitive component 2, distance E is defined and can be calculated from values α, β, and c.

FIG. 6 illustrates how the points in time and the corresponding solar altitudes of leading edge 7 of a respective shadow 6 reaches and finally leaves an individual and spacious light sensitive component 1 may be used to determine the distance E of the respective edge 11 of object 4 from the light sensitive component 1.

FIG. 7 shows a solid angle map 12 with the azimuth angle plotted in the horizontal direction and the altitude angle plotted in the vertical direction. Ranges 13 and 14 with predominant probability of shadowing of two different light sensitive components, respectively, of a PV system caused by a shadow of a stationary object are entered into the map. The stationary object has a different position relative to the two light sensitive components, i.e. it is located in a different direction from the two components. The predominant probability values of shadowing are determined by evaluation of the signals of the two light sensitive components, respectively, over a period of a year. The distance of the shadowing obstacle may be determined according to the basic principles of FIG. 5 and FIG. 6 based on the determination of an offset between ranges 13 and 14, such as an offset between the center points of the corresponding areas of the ranges. In addition, a change of the shape of ranges 13 and 14 may be used to determine the type or the orientation of the shadowing obstacle.

The solid angle map is just to be understood as one example of an illustration of the shadowing probability as a function of the solar altitude. The map may also include information about the distance of the shadowing objects and therefore may be extended to three-dimensionally display the position of the shadowing objects. Within this document, a solid angle map is to be construed as any map-type illustration formed on the basis of direction and distance data generated by analysis of the transition of a shadow of a stationary object, in particular volume pixel maps. In this map type, the position information of shadowing edges may be complemented by an assumed extension of the shadowing object between the determined edges. Additionally, information about the nature of the obstacle determined as described above, and/or forecasts of the scope of energy loss by those obstacles may be integrated into the map. This way, a comprehensive diagram of objects limiting the energy production of the PV system under analysis may be produced.

1. A method of localizing stationary objects causing a temporary shadowing of light sensitive components of a PV system, comprising:
analyzing an electrical signal of the light sensitive components with regard to an occurrence of a shadowing event caused by the stationary object;
determining from a solar altitude associated with the shadowing event a direction of the stationary object causing the shadowing event, wherein analyzing the electrical signal comprises taking into account a shadow movement of the object as a function of the solar altitude; and
determining a distance of the object from the analysis of the electrical signal.

2. The method of claim 1, wherein analyzing the electrical signal comprises distinguishing between stationary objects and non-stationary objects as a cause of the shadowing event based on the analysis of the electrical signal.

3. The method of claim 1, wherein analyzing the electrical signal comprises comparing electrical signals from different ones of the light sensitive components to detect the occurrence of a shadowing event caused by a stationary object.

4. The method of claim 1, wherein analyzing the electrical signal comprises analyzing the electrical signal for repetition at substantially the same solar altitude over a plurality of days to detect the occurrence of a shadowing event caused by a stationary object.

5. The method of claim 1, further comprising regarding detected shadowing events within a fault monitoring of the PV system to avoid false warnings.

6. The method of claim 1, wherein analyzing the electrical signal comprises determining a first solar altitude at which a shadow edge transits the light sensitive components.

7. The method of claim 6, wherein the distance of the object is determined based on the first solar altitude.

8. The method of claim 7, further comprising distinguishing between a single object and a plurality of objects causing temporary shadowing by analyzing distances of object edges associated with shadow edges transiting the light sensitive components.

9. The method of claim 1, wherein analyzing the electrical signal comprises analyzing frequency components of the electrical signal during a transition period of shadow edges across the light sensitive components to determine a type of object causing temporary shadowing.

10. The method of claim 1, wherein analyzing the electrical signal comprises analyzing the electrical signal associated with shadowing caused by a stationary object for seasonal changes to determine a type of object causing temporary shadowing.

11. The method of claim 1, wherein the electrical signal is analyzed from a single light sensitive component with a lateral extent in a direction of the shadow movement or from a plurality of light sensitive components distributed along the direction of the shadow movement.

12. The method of claim 1, wherein analyzing the electrical signal comprises analyzing a plurality of the electrical signals from a plurality of light sensitive components arranged in a spaced manner in a direction of the shadow movement.

13. The method of claim 1, wherein determining a distance of the object comprises performing a triangulation calculation.

14. The method of claim 1, further comprising determining an energy loss associated with the object based on the analyzed electrical signal.

15. The method of claim 1, further comprising entering the solar altitude associated with the shadowing event into a solid angle map.

16. The method of claim 15, wherein the direction of a feature of the stationary object causing the shadowing event is derived from the solid angle map.

17. The method of claim 15, wherein the distance of at least a feature of the stationary object causing the shadowing event is added to the solid angle map.

18. The method of claim 15, wherein an anergy loss associated with the stationary object causing the shadowing event is added to the solid angle map.

19. The method of claim 1, wherein the light sensitive components of the PV system are selected from the group of a solar cell, a string of solar modules, and additional photo-detectors.
